(19) United States
(12) Patent Application Publication
(10) Pub. No.: US 2012/0299947 A1
(43) Pub. Date: Nov. 29, 2012

(54) DISPLAY DEVICE

(75) Inventors: Kazuhiko Tsuda, Osaka-shi (JP); Kozo Nakamura, Osaka-shi (JP)

(73) Assignee: SHARP KABUSHIKI KAISHA, Osaka-shi, Osaka (JP)

(21) Appl. No.: 13/574,336

(22) PCT Filed: Dec. 28, 2010
(86) PCT No.: PCT/JP2010/073735

§ 371 Date: Jul. 20, 2012

(30) Foreign Application Priority Data
Jan. 22, 2010 (JP) 2010-012547

(51) Int. Cl. G09G 5/02

(52) U.S. Cl. 345/589

(57) ABSTRACT

The present invention provides a display device, the display quality of which is not spoilt by dark lines . The display device includes a plurality of pixels arranged in a matrix pattern, and each of the pixels includes sub-pixels of four different colors. The display device is designed to switchably run in a mode in which all the sub-pixels of four different colors are involved to produce an image and in a mode in which an image is produced while a sub-pixel with the maximum luminous intensity among the sub-pixels of four different colors is in an off-state. The sub-pixel with the maximum luminous intensity and a sub-pixel with the minimum luminous intensity among the sub-pixels of four different colors are not arranged next to each other.

### TECHNICAL FIELD

The present invention relates to a display device. More specifically, the present invention relates to a display device capable of color display.

### BACKGROUND ART

Recently, liquid crystal display devices capable of color display have been widely used as display devices in personal computers, video cameras, car navigation systems, and the like.

In order to offer liquid crystal display devices with higher pixel brightness, RGBW mode liquid crystal display devices (hereinafter, referred to as RGBW liquid crystal display devices) have been proposed. In these RGBW liquid crystal display devices, transparent filters (W) are used in addition to RGB filters, which have been conventionally used in RGB systems.

Also, a technique that enables an RGBW liquid crystal display device to run in an RGB mode has been developed (for example, Patent Literature 1).

### CITATION LIST

### Patent Literature

Patent Literature 1: JP 2002-149116 A

### SUMMARY OF INVENTION

### Technical Problem

However, an RGBW liquid crystal display device running in an RGB mode may provide grainy images that appear to have some dark lines on its display.

The present invention has been made in view of the above problem and an object of the present invention is to provide a display device, the display quality of which is not spoilt by dark lines.

### Solution to Problem

The present inventors studied various display devices to find a way to avoid poor display quality attributed to dark lines, and focused on arrangement patterns of sub-pixels of various colors in each pixel. As a result, regarding RGBW liquid crystal display devices, the following reasons for the above-mentioned problem were found out.

Specifically, an example of stripe patterns is shown in FIG. 9 in which a red (R) sub-pixel (also referred to as R pixel) 3R, a green (G) sub-pixel (also referred to as G pixel) 3G, a blue (B) sub-pixel (also referred to as B pixel) 3B, and a white (W) sub-pixel (also referred to as W pixel) 3W are arranged in this order; and

examples of 2×2 (matrix) patterns are shown in FIGS. 10 and 11 in which a B pixel 3B and a W pixel 3W are next to each other in the transverse or vertical direction.

In the case of the RGB mode, the W pixel is in an off-state, that is, serves as a black (Bk) sub-pixel (also referred to as Bk pixel). The B pixel has lower luminous intensity than the R and G pixels by nature, and therefore looks darker than the other sub-pixels. Therefore, in the above examples, the Bk pixel is next to the B pixel which has lower luminous intensity than the R and G pixels by nature.

Accordingly, in the case of the stripe pattern, as shown in FIG. 12, the Bk pixels 3BK are respectively arranged next to the B pixels 3B with low luminous intensity in the RGB mode, and these sub-pixels together form wide, dark, apparent lines 11, which results in poor display quality.

In the case of the 2×2 patterns, as shown in FIGS. 13 and 14, the Bk pixels 3BK are respectively arranged next to the B pixels 3B with low luminous intensity in the RGB mode, and these sub-pixels together form dark lines 12 in the transverse or vertical direction, which results in poor display quality.

Further studies by the present inventors revealed that in the display mode in which the sub-pixels with the maximum luminous intensity are in the off-state, the sub-pixels in the off-state are away from the sub-pixels with the minimum luminous intensity and these dark sub-pixels are mixed with other sub-pixels with relatively high luminous intensity in the case that the sub-pixels with the maximum luminous intensity are not arranged next to the sub-pixels with the minimum luminous intensity. Thus, this structure was proved to prevent visible dark lines. Consequently, the present inventors has found a way to solve the above problem and completed the present invention.

Specifically, the present invention provides a display device including a plurality of pixels arranged in a matrix pattern, and each of the pixels includes sub-pixels of four different colors. The display device is designed to switchably run in a mode in which all the sub-pixels of four different colors are involved to produce an image and in a mode in which an image is produced while a sub-pixel with the maximum luminous intensity among the sub-pixels of four different colors is in an off-state, and the sub-pixel with the maximum luminous intensity and a sub-pixel with the minimum luminous intensity among the sub-pixels of four different colors are not arranged next to each other.

The structure of the display device of the present invention is not particularly limited by other components as long as it includes these essential components.

The following description is offered to illustrate preferable forms of the display device of the present invention in detail.

Preferably, the sub-pixels of four different colors are arranged in a stripe pattern. This structure more successfully gives improved display quality although stripe patterns may cause wide dark lines 11 as described above.

Alternatively, these sub-pixels of four different colors may be arranged in a 2×2 pattern. In this case, a 2×2 pattern that successfully gives improved display quality is provided.

Preferably, these sub-pixels of four different colors include a red sub-pixel, a green sub-pixel, a blue sub-pixel, and a white sub-pixel, the sub-pixel with the maximum luminous intensity corresponds to the white sub-pixel, and the sub-pixel with the minimum luminous intensity corresponds to the blue sub-pixel. Regarding RGBW display devices which include a W pixel in addition to sub-pixels of three primary colors RGB, this structure successfully improves the display quality.

Or these sub-pixels of four different colors may include a red sub-pixel, a green sub-pixel, a blue sub-pixel, and a yellow sub-pixel, and therefore the sub-pixel with the maximum luminous intensity may correspond to the yellow sub-pixel and the sub-pixel with the minimum luminous intensity may correspond to the blue sub-pixel. Regarding RGBY display devices which include a yellow sub-pixel (also referred to as Y pixel) in addition to sub-pixels of three primary colors RGB, this structure successfully improves the display quality.

### Advantageous Effects of Invention

The display device of the present invention shows display quality which is not spoilt by dark lines.

### BRIEF DESCRIPTION OF DRAWINGS

FIG. 1 is a plan view schematically illustrating the structure of a liquid crystal display device of embodiment 1;

FIG. 2 is a plan view schematically illustrating a sub-pixel pattern of the liquid crystal display device of embodiment 1 (in the RGBW mode);

FIG. 3 is a plan view schematically illustrating a sub-pixel pattern of the liquid crystal display device of embodiment 1 (in the W off-state);

FIG. 4 is a plan view schematically illustrating a sub-pixel pattern of a variant of the liquid crystal display device of embodiment 1 (in the W off-state);

FIG. 5 is a plan view of the structure of a variant of the liquid crystal display device of embodiment 1;

FIG. 6 is a plan view schematically illustrating a sub-pixel pattern of a variant of the liquid crystal display device of embodiment 1 (in the RGBW mode);

FIG. 7 is a plan view schematically illustrating a sub-pixel pattern of a variant of the liquid crystal display device of embodiment 1 (in the W off-state);

FIG. 8 is a plan view schematically illustrating a sub-pixel pattern of a variant of the liquid crystal display device of embodiment 1 (in the W off-state);

FIG. 9 is a plan view schematically illustrating a stripe pattern of a liquid crystal display device of a comparative embodiment (in the RGBW mode);

FIG. 10 is a plan view schematically illustrating a 2×2 pattern of a liquid crystal display device of a comparative embodiment (in the RGBW mode);

FIG. 11 is a plan view schematically illustrating a 2×2 pattern of a liquid crystal display device of a comparative embodiment (in the RGBW mode);

FIG. 12 is a plan view schematically illustrating a stripe pattern of a liquid crystal display device of a comparative embodiment (in the W off-state);

FIG. 13 is a plan view schematically illustrating the 2×2 pattern of a liquid crystal display device of Comparative Embodiment (in the W off-state);

FIG. 14 is a plan view schematically illustrating the 2×2 pattern of a liquid crystal display device of a comparative embodiment (in the W off-state);

FIG. 15 is a photograph of a display of a liquid crystal display device of Example 1; and

FIG. 16 is a photograph of a display of a liquid crystal display device of Comparative Example 1.

### DESCRIPTION OF EMBODIMENTS

The following description is offered to illustrate the present invention in more detail by way of embodiments with reference to the drawings. It should be noted that the present invention is not limited only to these embodiments.

The term “pixel” herein means a smallest element on a display which is controlled to provide a color and/or brightness independently of others.

The term “sub-pixel” means a point of a different color in each pixel.

The luminous intensity Iᵥ (unit: cd) is determined by the equation:

Iᵥ=Kₘ∫Iₑ(λ)·V(λ)dλ.

Kₘ is the maximum luminous efficacy, Iₑ (λ) is the spectral radiant intensity at a wavelength λ, and V(λ) is the standard spectral luminous efficacy.

The luminous intensity of the sub-pixels of different colors was evaluated based on a comparison of the brightnesses of the display which were measured while supplying a signal for lighting each sub-pixel to a display panel (for example, liquid crystal display panel). A spectroradiometer SR-3AR (TOPCON TECHNOHOUSE CORP.) was used for the evaluation.

### Embodiment 1

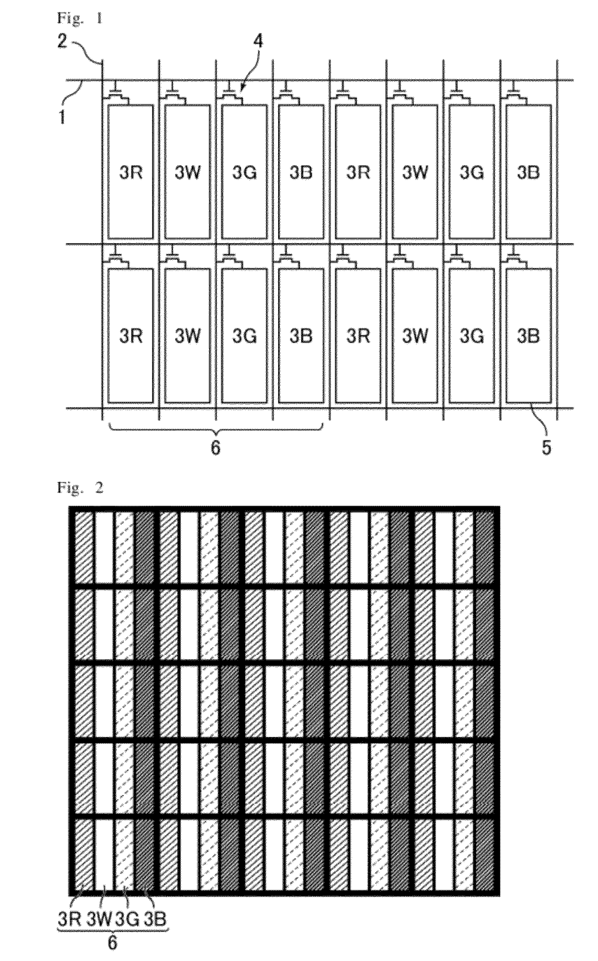

The liquid crystal display device of the present embodiment is provided with gate bus lines 1 and source bus lines 2, as shown in FIG. 1. The numbers of the gate bus lines 1 and the source bus lines 2 are m (natural number) and n (natural number), respectively. The gate bus lines 1 are parallel to one another and the source bus lines 2 are perpendicular to the gate bus lines 1 and parallel to one another. The gate bus lines 1 are connected to a gate driver (not shown) and the source bus lines 2 are connected to a source driver (not shown).

An R pixel 3R, a G pixel 3G, a B pixel 3B, and a W pixel 3W (sub-pixel for improving the brightness) are provided in each space defined by the gate bus lines 1 and the source bus lines 2.

TFTs (thin film transistors) 4 are provided near the intersections of the gate bus lines 1 and the source bus lines 2. The gate bus lines 1, the source bus lines 2, and display electrodes 5 of the respective sub-pixels 3R, 3G, 3B, and 3W are connected to gates, sources, and drains of the TFTs 4, respectively. An electrode (common electrode, not shown in the figures) facing the display electrodes 5 is connected to a circuit (not shown) for supplying a common electrode.

The liquid crystal display device of the present embodiment is further provided with a liquid crystal layer disposed between a TFT substrate including the gate bus lines 1, the source bus lines 2, the TFTs 4, the display electrodes 5, and the like and a color filter substrate including the common electrode.

Portions of the color filter substrate corresponding to the R pixel 3R, the G pixel 3G, and the B pixel 3B are provided with R, G, and B color filters, respectively. No color filter is provided on a portion corresponding to the W pixel 3W, or a transparent colorless filter is provided thereon.

Thus, each of the pixels 6 of the liquid crystal display device of the present embodiment consists of four sub-pixels of RGBW, and these sub-pixels of four colors RGBW (color filters for RGBW) are arranged in a stripe pattern.

The liquid crystal display device of the present embodiment can be used as an RGBW liquid crystal display device and as an RGB liquid crystal display device, like the liquid crystal display device of Patent Literature 1. Namely, the liquid crystal display device can run in a mode in which the W pixel 3W is lit and all the sub-pixels of RGBW are involved to produce images (RGBW mode), and also can run in a mode in which the W pixel 3W is off and only the sub-pixels of RGB are involved to produce images (RGB mode).

Specifically, in the RGBW mode, RGBW signals are generated from RGB input signals (externally input image signals for three colors RGB) and used to drive the sub-pixels of RGBW. In this case, a signal corresponding to brightness information (common information of the RGB input signals) among the RGB input signal components is input to the W pixel.

On the other hand, in the RGB mode, the RGB input signals are used as they are to drive the sub-pixels of RGB. In this mode, the W pixel is not used (lit) and serves as a Bk pixel.

This structure can improve the brightness because it can light the W pixel when it is in bright environment, for example, in the outside or near a window. Although the brightness is improved, this running mode disadvantageously reduces the color reproduction range because white is mixed in the displayed colors. However, in bright environment, human eyes adapt to this bright environment and recognize colors with relatively low brightness as “black”. As a result, the contrast appears to be increased and faint colors also look darker. Therefore, the presence of the white does not cause a problem.

In contrast, the color quality in the fainter display mode, that is, the display mode with a smaller color reproduction range appears to be very bad in dark environment, for example, at night or in a room. Therefore, the display mode using only the RGB pixels without lighting the W pixel is preferable in dark environment.

To determine a suitable one from these modes, a brightness sensor may be provided near the display.

In the present embodiment, as shown in FIG. 2, the R pixel 3R, the W pixel 3W, the G pixel 3G, and the B pixel 3B are arranged in the stated order in the transverse direction. Namely, the W pixel 3W and the B pixel 3B which have the maximum and minimum luminous intensities, respectively, among the RGBW pixels in the on-state are not next to each other. In other words, the W pixel 3W and the B pixel 3B do not share the boundary.

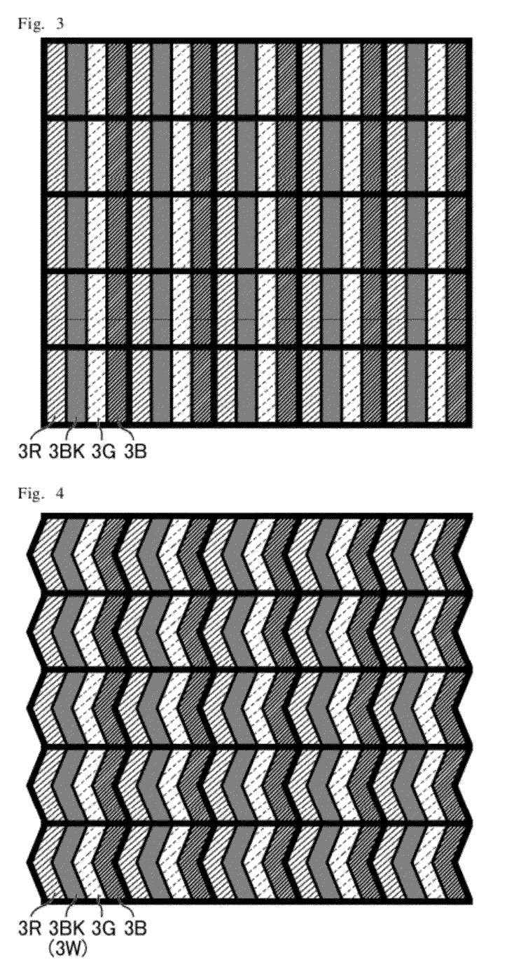

Therefore, in the case that the W pixel 3W is in the off-state and serves as a Bk pixel, as shown in FIG. 3, the B pixel 3B and the Bk pixel 3BK are respectively sandwiched between the R pixel 3R and the G pixel 3G. Specifically, both the darkest Bk pixel 3BK and the B pixel 3B having the minimum luminous intensity among the RGB pixels are interleaved with the R pixel 3R and the G pixel 3G which have relatively high luminous intensities. Therefore, this structure can avoid wide dark lines of the Bk pixel 3BK and the B pixel 3B, and provide an image that appears to be free from dark lines on the display, and therefore improves the display quality.

The following description is offered to illustrate variants of the present embodiment.

The order of the sub-pixels is not particularly limited to the R, W (Bk), G, and B pixels, and may be another order such as RBGW pixels, GBRW pixels, or GWRB pixels.

However, the orders such as BRGW pixels and WRGB pixels in which the W pixel and the B pixel are disposed on both sides in each pixel are not preferable because the B pixel and the W (Bk) pixel are next to each other across the boundary of adjacent pixels and may cause a wide dark line between the adjacent pixels.

Although the sub-pixels have a rectangular planar shape in FIGS. 1 to 3, the planar shape of the sub-pixels is not particularly limited and may be bent as shown in FIG. 4, and as a result, may form a zigzag stripe pattern.

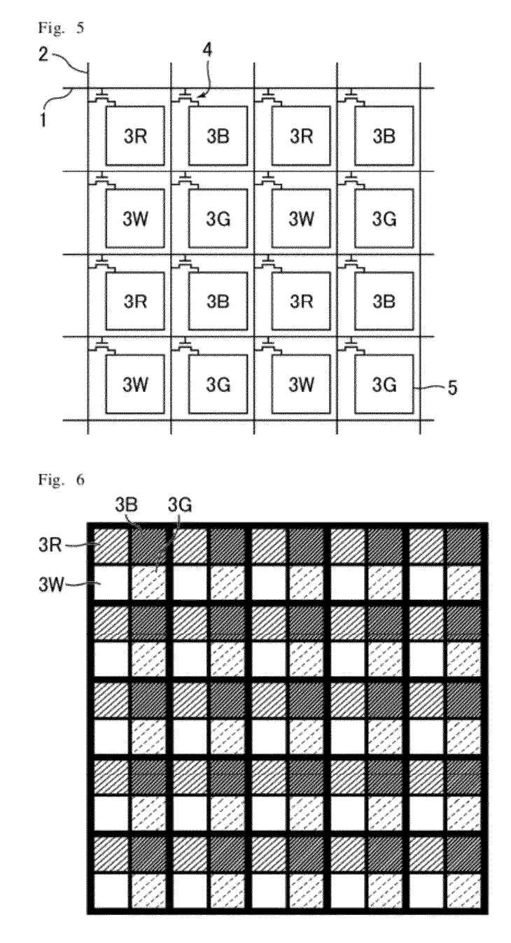

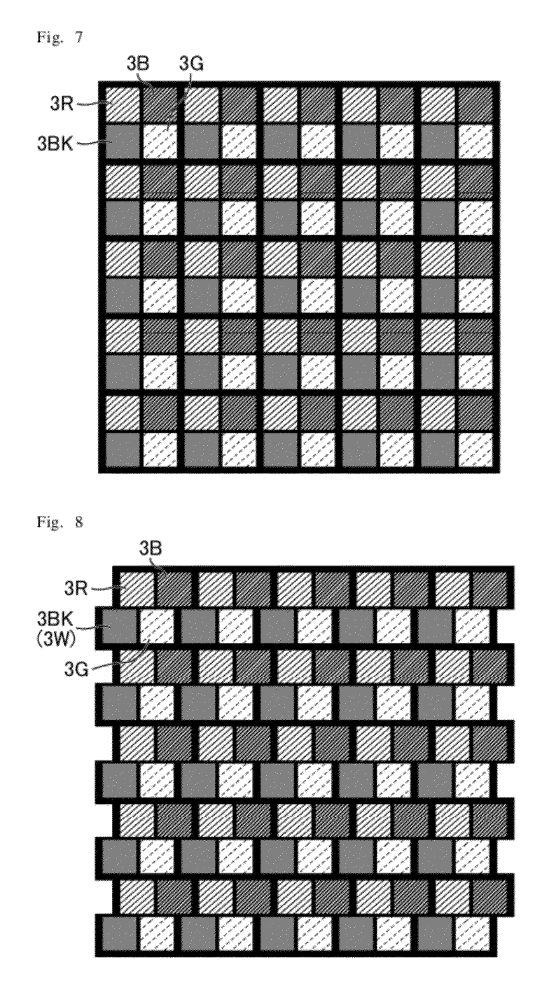

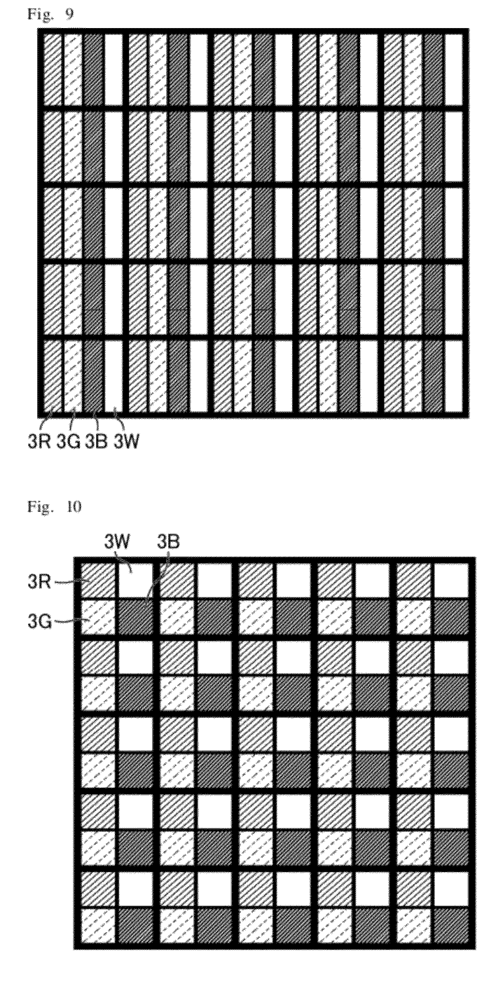

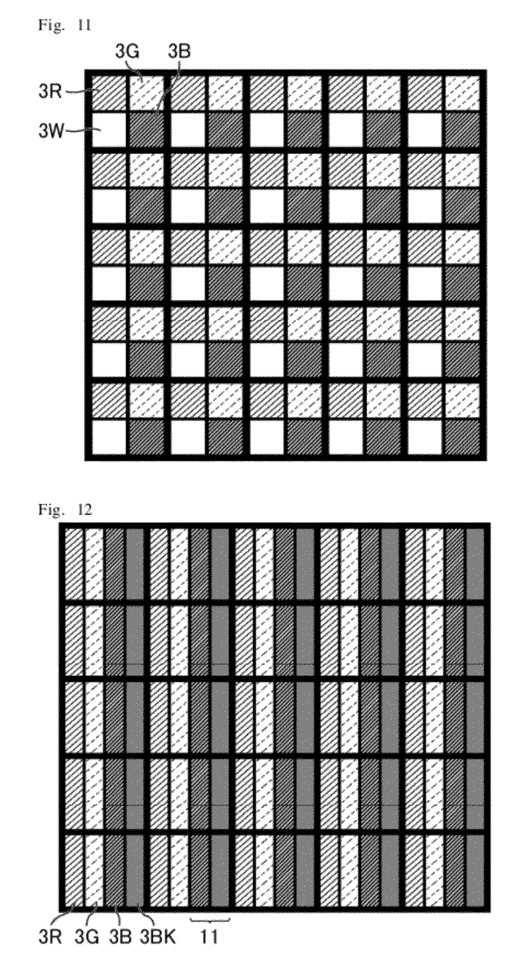

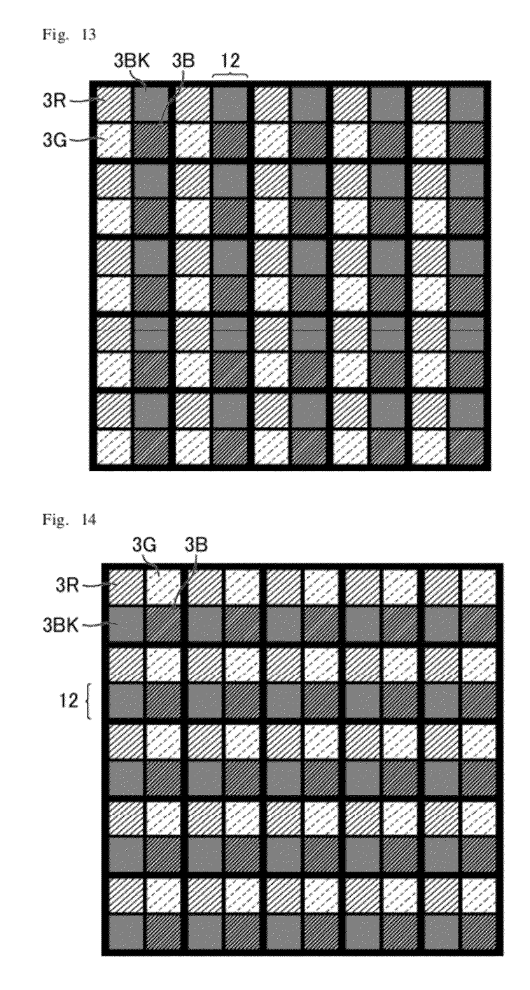

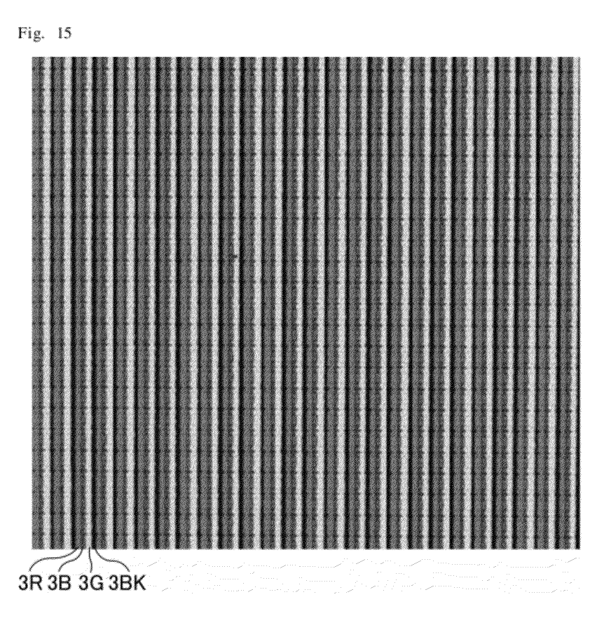

The arrangement pattern of the sub-pixels is not particularly limited to the stripe pattern, and may be in a 2×2 pattern as shown in FIGS. 5 and 6. Specifically, each pixel consists of four sub-pixels of RGBW which form 2×2 grids. The R pixel 3R and the B pixel 3B are arranged in the stated order in the upper row from left and the W pixel 3W and the G pixel 3G are arranged in the stated order in the lower row from left.

In this structure, the B pixel 3B and the Bk pixel 3BK are located at diagonal positions with respect to each other and are mixed with the R pixel 3R and the G pixel 3G as shown in FIG. 7 when the W pixel 3W is in the off-state and serves as a Bk pixel 3BK. Therefore, this structure also can avoid dark lines of the Bk pixel 3BK and the B pixel 3B.

The order of the sub-pixels in the 2×2 pattern is also not particularly limited to the above example, and for example, the B pixel and the R pixel may be arranged in the stated order in the upper row from left and the G pixel and the W pixel may be arranged in the stated order in the lower row from left. The upper and lower rows or the left and right columns may be interchanged in each example.

In FIGS. 5 to 7, the planar shape of the sub-pixels is substantially square. The planar shape, however, is not particularly limited and may be substantially rectangular.

As shown in FIG. 8, the two sub-pixels in the upper row may be offset from the two sub-pixels in the lower row to some extent, for example, by one-half sub-pixel pitch in the transverse direction. Likewise, the two sub-pixels in the left column may be offset from the two sub-pixels in the right column to some extent, for example, by one-half sub-pixel pitch in the vertical direction.

Alternatively, a Y pixel may be used in addition to the sub-pixels of three primary colors RGB instead of the W pixel. In this case, it is possible to produce images in a mode in which the Y pixel is in the off-state and serves as a Bk pixel, and to prevent dark lines which spoil the display quality when the Y pixel is in the off-state. In addition, this structure has a wider color reproduction range compared to the case in which the W pixel is used.

The display device of the present invention is not particularly limited, provided that it includes sub-pixels of four different colors. Specifically, the display device of the present invention may be a liquid crystal display device (LCD), a cathode-ray tube (CRT), an organic electroluminescence display device (OELD), a plasma display panel (PDP), a field emission display (FED), or the like. In particular, the display device of the present invention is suitably used for liquid crystal display devices that have been attracting as display devices for digital signage among these examples because the display device of the present invention can be suitably used in both bright environment and dark environment.

### Example 1

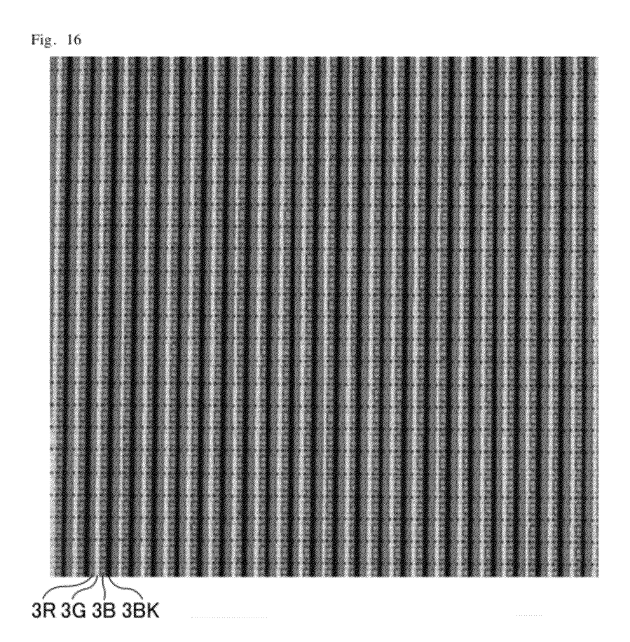

In Example 1, a liquid crystal display device having a stripe pattern in which an R pixel, a B pixel, a G pixel, and a W pixel are arranged in the stated order in the transverse direction was produced. As shown in FIG. 15, the display was observed while the R pixel 3R, the B pixel 3B, and the G pixel 3G were lit and the W pixel was in the off-state and was serving as a Bk pixel 3BK. In the present example, no wide dark line was observed and the display quality was good.

### Comparative Example 1

In Comparative Example 1, a liquid crystal display device having a stripe pattern in which an R pixel, a G pixel, a B pixel, and a W pixel are arranged in the stated order in the transverse direction was produced. As shown in FIG. 16, the display was observed while the R pixel 3R, the B pixel 3B, and the G pixel 3G were lit and the W pixel was in the off-state and was serving as a Bk pixel 3BK. In this comparative example, wide dark lines of the Bk pixels 3BK and the B pixels 3B were observed and the display quality was worse than that of Example 1.

The present application claims priority to Patent Application No. 2010-12547 filed in Japan on Jan. 22, 2010 under the Paris Convention and provisions of national law in a designated State, the entire contents of which are hereby incorporated by reference.

### REFERENCE SIGNS LIST

1: Gate bus line
2: Source bus line
3: Sub-pixel
4: TFT
5: Display electrode (pixel electrode)
6: Pixel

1. A display device comprising a plurality of pixels arranged in a matrix pattern,
wherein each of the pixels comprises sub-pixels of four different colors,
the display device is designed to switchably run in a mode in which all the sub-pixels of four different colors are involved to produce an image and in a mode in which an image is produced while a sub-pixel with the maximum luminous intensity among the sub-pixels of four different colors is in an off-state, and
the sub-pixel with the maximum luminous intensity and a sub-pixel with the minimum luminous intensity among the sub-pixels of four different colors are not arranged next to each other.

2. The display device according to claim 1,
wherein the sub-pixels of four different colors are arranged in a stripe pattern.

3. The display device according to claim 1,
wherein the sub-pixels of four different colors are arranged in a 2×2 pattern.

4. The display device according to claim 1,
wherein the sub-pixels of four different colors include a red sub-pixel, a green sub-pixel, a blue sub-pixel, and a white sub-pixel,
the sub-pixel with the maximum luminous intensity corresponds to the white sub-pixel, and
the sub-pixel with the minimum luminous intensity corresponds to the blue sub-pixel.

5. The display device according to claim 1,
wherein the sub-pixels of four different colors include a red sub-pixel, a green sub-pixel, a blue sub-pixel, and a yellow sub-pixel,
the sub-pixel with the maximum luminous intensity corresponds to the yellow sub-pixel, and
the sub-pixel with the minimum luminous intensity corresponds to the blue sub-pixel.
